(19) United States
(12) Patent Application Publication
(10) Pub. No.: US 2009/0052701 A1
(43) Pub. Date: Feb. 26, 2009

(54) Spatial teleconferencing system and method

(76) Inventor: Robert W. Reams, Mill Creek, WA (US)

Correspondence Address: Mr. Christopher John Rourk;Jackson Walker LLP, 901 Main Street, Suite 6000, DALLAS, TX, 75202, US

(21) Appl. No.: 11/894,200

(22) Filed: Aug. 20, 2007

(51) Int. Cl. H04R 5/02

(52) U.S. Cl. 381/309

(57) ABSTRACT

A system for processing audio data is provided. A left channel system receives a first channel of audio data, and a right channel system receiving a second channel of audio data. A delay coupled to one of the left channel system and the right channel system provides a delay to one of the first channel of audio data and the second channel of audio data, wherein the delay causes an apparent location of a source to a listener to occur in a single location.

### FIELD OF THE INVENTION

The invention relates to systems for processing audio data, and more particularly to a system and method for controlling the apparent location of an audio source in a stereophonic listening environment.

### BACKGROUND OF THE INVENTION

Stereophonic headphones or other stereophonic systems are often used for communications. For example, a pilot may receive communications from a control or operations center, a co-pilot, a squadron leader and one or more automated systems over a set of stereophonic headphones. However, because such systems provide all channels of audio data at equal phase and volume levels, it can be difficult for the pilot to focus on a single channel of audio data. This problem can result in the failure of the pilot to distinguish the source of a communication or to understand the communication.

### SUMMARY OF THE INVENTION

In accordance with the present invention, a system and method are provided for spatial teleconferencing that allows a listener to distinguish sources of communications.

In particular, a system and method for spatial teleconferencing are provided that allow the apparent location of a communications source to be placed at a predetermined location in a stereophonic listening environment.

In accordance with an exemplary embodiment of the present invention, a system for processing audio data is provided. A left channel system receives a first channel of audio data, and a right channel system receiving a second channel of audio data. A delay coupled to one of the left channel system and the right channel system provides a delay to one of the first channel of audio data and the second channel of audio data, wherein the delay causes an apparent location of a source to a listener to occur in a single location.

The present invention provides many important technical advantages. One important technical advantage of the present invention is a system and method for providing apparent spatial separation between sound channels in a stereophonic environment that allows a listener to more readily identify the identity of a speaker as well as to distinguish what that speaker is saying in a multiple-speaker environment.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for providing spatial separation for a stereo output signal in accordance with an exemplary embodiment of a present invention;

FIG. 2 is a diagram of a system for decorrelating the phase of an input signal in accordance with exemplary embodiment of the present invention;

FIG. 3 is a flowchart of a method for decorrelating the phase of an input signal in accordance with an exemplary embodiment of the present invention;

FIG. 4 is a diagram of a system for decorrelating microphonic inputs into a mixer in accordance with an exemplary embodiment of the present invention;

FIG. 5 is a diagram of a system for decorrelating speaker outputs in accordance with an exemplary embodiment of the present invention; and

FIG. 6 is a diagram of a method for decorrelating sound signals in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

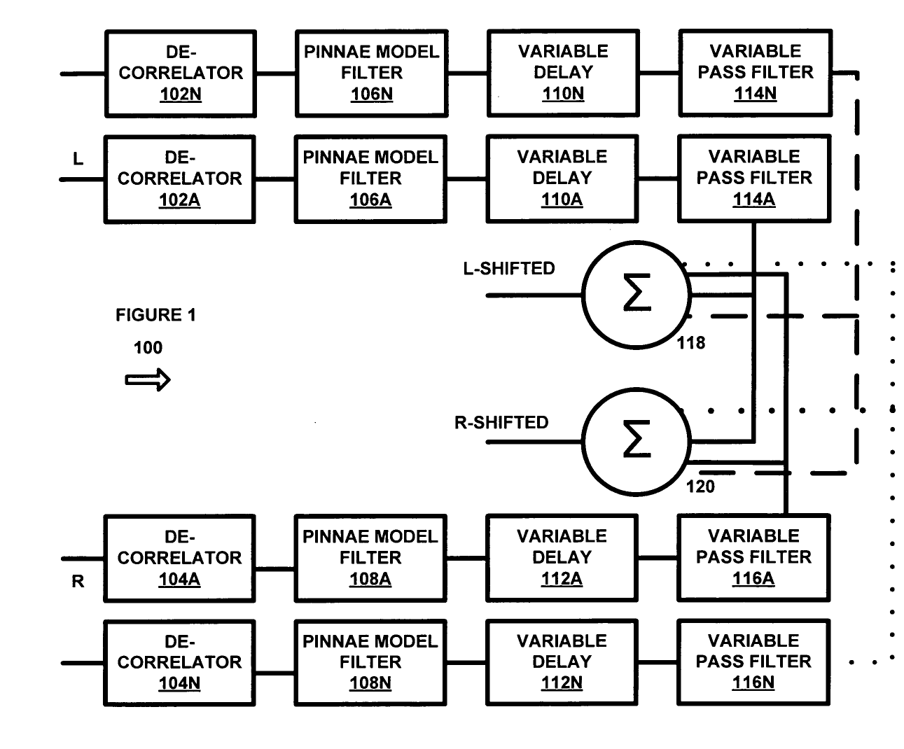

FIG. 1 is a diagram of a system 100 for providing spatial separation for a stereo output signal in accordance with an exemplary embodiment of a present invention. System 100 can be used to provide an apparent spatial location for a stereophonic output channel from a monaural input, so as to allow multiple voice channels to be provided to a stereophonic headset. In this manner, an apparent spatial location for an input channel is provided to a listener, so as to allow the listener to distinguish different input signals based on the apparent spatial location.

System 100 includes decorrelators 102A through 102N and 104A through 104N, each of which receives left and right channels, respectively. In one exemplary embodiment, the left and right channels can be a monaural signal, such that the left and right channels are the same signal and have the same phase. Decorrelators 102A through 102N and 104A through 104N can be implemented in hardware, software, or a suitable combination of hardware and software, and can be one or more software systems operating on a digital signal processing platform, a general purpose processing platform, or other suitable platforms. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Decorrelators 102A through 102N and 104A through 104N decorrelate the phase of the monaural signal received at the left and right inputs. In one exemplary embodiment, the left and right inputs can be transformed from a time domain to a frequency domain such that decorrelators 102A through 102N and 104A through 104N decorrelate the phase of the signal in the frequency domain. In this exemplary embodiment, a time to frequency domain transform system (not shown) is used to perform the time to frequency domain transformation of the input signal.

Pinnae model filters 106A through 106N and 108A through 108N receive the decorrelated left and right channel inputs and apply a pinnae model filter to the input. In one exemplary embodiment, the pinnae model can be a frequency filter based on the generalized response of human hearing to frequency inputs.

Variable delays 110A through 110N are coupled to pinnae model filters 106A through 106N and variable delays 112A through 112N are coupled to pinnae model filters 108A through 108N. Variable delays 110A through 110N and 112A through 112N provide an adjustable delay to the decorrelated and filtered signals, so as to generate an apparent spatial separation in the stereophonic output. In one exemplary embodiment, a listener that receives left and right channel inputs through a stereophonic listening device such as headphones may perceive a spatial separation based on the variable delay between the left and right channels. In a real-world environment, a listener determines the location of a point sound source based on the delay between when the sound signals are received at the listener's left and right ears. For example, a sound signal generated from a point sound source that is closer to a listener's left ear will be received at the left ear sooner than sound is received at the listener's right ear. This time delay allows the location of the point sound source to be determined. In this exemplary embodiment, the apparent location of an input channel can be moved relative to the listener based on the amount of variable delay settings of variable delays 110A through 110N and 112A through 112N. In one exemplary embodiment, the amount of variable delays 110A through 110N and 112A through 112N can vary from 230 to 600 microseconds, so as to represent the amount of delay that is typically observed in three-dimensional listening environments. Likewise, a single delay can be used for each pair of channels, the delays can be fixed so as to provide a predetermined spatial location for each pair of channels, or other suitable embodiments can be provided.

Variable pass filters 114A through 114N and variable pass filters 116A through 116N can be implemented in hardware, software, or a suitable combination of hardware and software, and can be one or more software systems operating on a general purpose processing platform. Variable pass filters 114A through 114N and 116A through 116N provide a variable band pass filter having a break point that can be related to the spatial separation of the left and right channels to the listener, and can be first order low pass filters, such as having a break point frequency of 2 kHz or other suitable frequencies. By adjusting the delay of variable delays 110A through 110N and 112A through 112N and the break point frequency of variable pass filters 114A through 114N and 116A through 116N, the apparent location of the signal received at left and right channel inputs can be altered for a listener using stereophonic headphones or suitable listening devices. Likewise, a single filter can be used for each pair of channels, the filters can be fixed so as to provide a predetermined spatial location for each pair of channels, or other suitable embodiments can be provided.

Summation systems 118 and 120 can be implemented in hardware, software, or a suitable combination of hardware and software, and can be used when one or more software systems are operating on a general purpose processing platform. Summation systems 118 and 120 receive the output from variable pass filters 114A through 114N and 116A through 116N and add the signals to output the left shifted channel signal and right shifted channel signal, respectively. In one exemplary embodiment, the left shifted channel outputs and right shifted channel outputs are frequency domain signal, and can be transformed back to the time domain by suitable frequency-to-time transform system (not explicitly shown).

In operation, system 100 allows left and right channel input signals to be processed so as to create an apparent spatial location when the signal is provided to stereophonic headphones or other suitable listening devices. System 100 utilizes variable time delay and frequency filters to create an apparent spatial separation to the listener. In addition, the left and right channel signals are decorrelated so as to eliminate any potential phase interference. Pinnae model filtering can be used to further optimize the apparent spatial location of the signal perceived by a listener through a stereophonic headphone device or other listening device so as to allow the left and right channel data to have a specific apparent location to the listener. In one exemplary embodiment, a plurality of left shifted and right shifted audio channels can be combined, such as to allow two or more audio inputs to be generated having different apparent spatial locations. In this manner, the user can distinguish various inputs based on their apparent spatial location. The variable delays and filters can also or alternatively be fixed, so as to provide a predetermined apparent spatial location for each of a plurality of input channels, such as to associate a predetermined source with a predetermined apparent location.

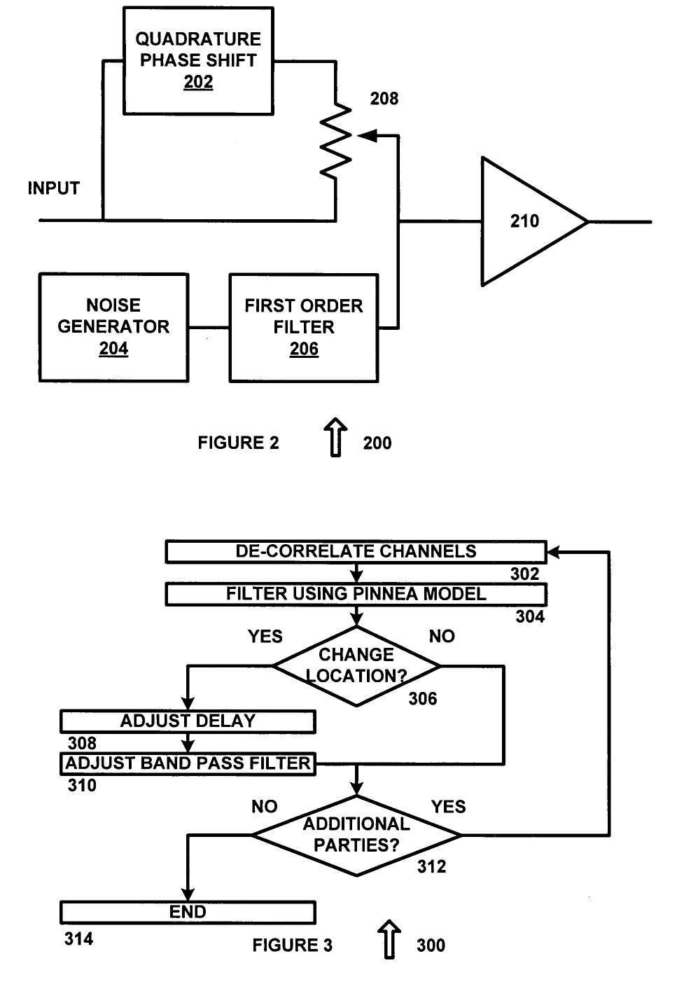

FIG. 2 is a diagram of a system 200 for decorrelating the phase of an input signal in accordance with exemplary embodiment of the present invention. System 200 includes noise generator 204, quadrature phase shift 202, first order filter 206 and amplifier 210, each of which can be implemented in hardware, software, or a suitable combination of hardware and software, and which can be one or more software systems operating on a general purpose processing platform, a digital signal processor, or other suitable platforms.

System 200 receives an input signal which is provided to quadrature phase shift 202. Quadrature phase shift 202 provides a 90 degree phase shift to the input signal. Potentiometer 208 provides an adjustable phase shift to the input signal ranging from 0 degrees to 90 degrees based on the setting of potentiometer 208. The setting of potentiometer 208 is randomly varied based on output from noise generator 204, which is filtered through a first order filter 206. In order to avoid generation of audio artifacts, noise generator 204 is controlled to generate random noise in a frequency range corresponding to the input frequency of the input signal. In one exemplary embodiment, the following relationships can be used to determine the frequency of noise to be generated based on the frequency range of the input signal:

| | | | |
|---|---|---|---|
| 0-50 | Hz | N(f) | ~10 hZ |
| 50-200 | Hz | N(2f) | ~20 hZ |
| 200-800 | Hz | N(4f) | ~40 hZ |
| 80-3.2 | kHz | N(8f) | ~80 hZ |
| 3.2-12.8 | kHz | N(16f) | ~160 hZ |

| | | |
|---|---|---|
| 12.8 kHz-∞ | N(32f) | ~320 hZ |

In one exemplary embodiment, noise generator 204 can be varied based upon the measured frequency of the input signal, different noise generators can be used based on different frequency bands for the input signal or other suitable embodiments can be used. The output signal from variable potentiometer 208 is provided to amplifier 210, which amplifies the signal.

In operation, system 200 provides a decorrelator for use in decorrelating the phase of an input signal. In one exemplary embodiment, decorrelator system 200 can be used to provide the correlation to adjust the apparent spatial relationship of a stereophonic input woofer for the suitable purposes as described herein.

FIG. 3 is a flowchart of a method 300 for decorrelating the phase of an input signal in accordance with an exemplary embodiment of the present invention. Method 300 begins at 302 where channels of sound are decorrelated. In one exemplary embodiment, the channels can be monaural signals that are decorrelated so as to decorrelate the in-phase monaural signal. Likewise, other suitable channels can be decorrelated. The method then proceeds to 304.

At 304, each channel of decorrelated audio data is filtered using a pinnae model or other suitable filters. The method then proceeds to 306.

At 306, it is determined whether a change in the apparent location to the listener of the input signal should be created. For example, two or more input channels can be used and an apparent location for each input channel can be created so as to allow a listener to perceive the apparent location of each input channel separately so as to facilitate the separation of the input channels by the listener. If it is determined at 306 that a change in location is not required, the method proceeds to 312. Otherwise the method proceeds to 308 where a variable delay is adjusted. In one exemplary embodiment, the amount of delay can be adjusted based on a range of 230 to 600 microseconds, where the amount of delay changes the apparent location of the audio channel. For example, if the amount of delay of the left channel relative to the right channel is 230 microseconds, then the apparent location of the sound to the listener will be closer to the center of the listener than the right side. Likewise, if the delay between the left and right channel is 600 microseconds, the apparent location of the sound will be closer to the left side of the listener. Other suitable delays can also or alternatively be used. In another exemplary embodiment, a predetermined location can be assigned based on the source of a sound channel. In this exemplary embodiment, if the listener is a pilot, then the location of communication channel received from a central control location can be assigned to a first location, such as the listener's left side, the location of a communications channel received from a co-pilot can be assigned to a second location, such as left of center of the listener, the location of a communications channel received from a squadron leader can be assigned to a third location, such as right of center of the listener, and the location of a communications channel received from voice commands or instructions from guidance or weapons systems can be assigned to a fourth location, such as the listener's right side.

After the delay is adjusted at 308, the method proceeds to 310 where a band pass filter is adjusted. In one exemplary embodiment, the band pass filter can be a first order band pass filter having a break point at approximately 2 khZ, where the frequency of the band pass is adjusted based on the frequency of the input data or other suitable factors. The method then proceeds to 312.

At 312, it is determined whether additional parties or channels should be added. In one exemplary embodiment, method 300 can be used to provide spatial separation between input channels for two or more inputs to a person using stereophonic headphones or other suitable equipment for listening to the output, such as a pilot or other suitable personnel who are receiving voice channel data from various parties such as ground control, co-pilots, or other suitable parties. If it is determined at 312 that additional parties are to be added, the method returns to 302. Otherwise the method proceeds to 314 and terminates.

In operation, method 300 allows changes to be made to provide apparent spatial separation to a listener for two or more input channels. Method 300 allows different voice channels to be processed so as to create an apparent location for each voice channel, where the apparent locations can be changed or modified based upon the number of voice channels, parties, or other suitable sound inputs.

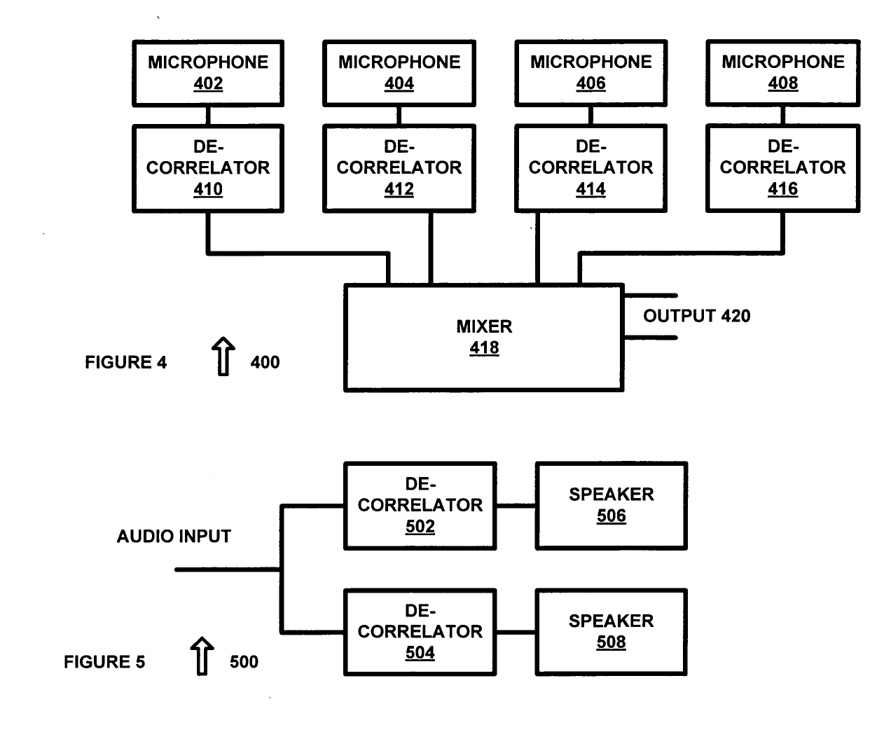

FIG. 4 is a diagram of a system 400 for decorrelating microphonic inputs into a mixer in accordance with an exemplary embodiment of the present invention. System 400 allows microphonic input to be decorrelated so as to avoid phase distortion caused by overlap of signals received at various microphones.

System 400 includes microphones 402 through 408, each of which is coupled to decorrelators 410 through 416, respectively. As used herein, the “couple” and its cognate terms such as “coupled” or “couples” can include a physical connection (such as through a copper conductor), a virtual connection (such as through randomly assigned data memory locations), a logical connection (such as through one or more logical devices), other suitable connections, or a suitable combination of such connections.

Decorrelators 410 through 416 are coupled to mixer 418, which receives the inputs from decorrelators 410 through 416 and generates a stereo output 420. Mixer 418 can be a standard mixer that is used to mix a plurality of signal channel inputs so as to generate a stereo output.

In operation, system 400 applies random phase decorrelation to inputs received at microphones 402 through 408, so as to avoid phase distortion that may be caused by the delayed reception of sound signals at each microphone. In one exemplary embodiment, microphones 402 and 404 can be placed in proximity to each other, such as to record sound signals from a snare drum and a cymbal of a drum set, respectively. Because the sound signals received at microphone 404 will include some sound signals generated by the snare drum that is slightly out of phase with the sound signals received from the snare drum at microphone 402 (because of the time delay), and the sound signals received at microphone 402 will include some sound signals generated by the cymbal that is slightly out of phase with the sound signals received from the cymbal at microphone 404 (because of the time delay), audio artifacts will be created when the sound signals are mixed because of the phase differences from the different sound sources. In an environment where multiple microphones are used for multiple different sound sources, the creation of audio artifacts can be a significant impediment to creating a sound mix that does not have an unacceptable level of such audio artifacts.

By decorrelating the signals received by microphones 402 and 404 using phase decorrelators 410 and 412, the effect of picking up out-of-phase cymbal sound signals at microphone 402 and out of phase snare drum sound signals at microphone 404 can be reduced or eliminated, so as to allow the operator of mixer 418 to more readily mix the sound signals received from the decorrelators 410 and 412 without having to compensate for phase distortion and creation of audio artifacts. As such, system 400 can be used in environments where a large number of microphones are provided that receive sound signals from multiple sources but which are oriented for receiving sound from primarily a single source. In this manner, the decorrelated signal inputs can help prevent the creation of phase distortion that can generate audio artifacts. The generation of such audio artifacts renders the job of mixing such stereo signals more difficult, such that decorrelating the phase of the inputs reduces the complexity of mixing and provides improved stereo outputs 420.

FIG. 5 is a diagram of a system 500 for decorrelating speaker outputs in accordance with an exemplary embodiment of the present invention. System 500 allows decorrelation of audio signals provided to multiple speakers so as to avoid phase distortion and interference from each speaker.

System 500 includes decorrelators 502 and 504, which receive audio input and perform phase decorrelation on the audio input. In one exemplary embodiment, the audio input can include an audio signal that has been amplified and that is to be provided to speakers 506 and 508, such as a “tweeter” and “woofer” speaker pair that has been optimized for providing improved performance over a frequency range that is wider than can be properly handled by a single speaker. While a crossover filter is typically used to provide the high frequency signals from audio input to the tweeter and the low frequency signals to the woofer, both speakers may receive the output signal within the crossover frequency band. In this exemplary embodiment, decorrelators 502 and 504 provide phase decorrelation so as to avoid phase interference in the crossover region for the signals provided to speakers 506 and 508. In this manner, audio artifacts are not created by phase distortions created by the crossover filter or the signals provided to speakers 506 and 508.

Likewise, in other exemplary embodiments, speakers 506 and 508 can be speakers in different locations that are providing the same audio output over the same frequency range, where decorrelators 502 and 504 are used to decorrelate phase data. In this exemplary embodiment, speakers 506 and 508 may be providing parametric stereo signal, such as where the phase information has been removed, such that decorrelators 502 and 504 can be used to ensure that phase information is not inadvertently created between speakers 506 and 508 so as to create audio artifacts.

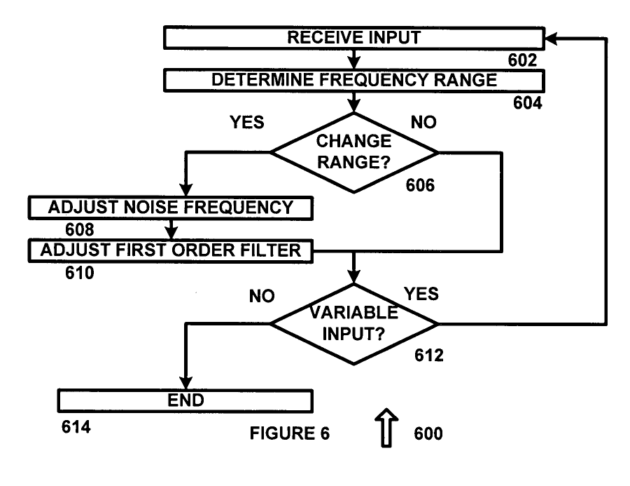

FIG. 6 is a diagram of a method 600 for decorrelating sound signals in accordance with an exemplary embodiment of the present invention. In one exemplary embodiment, method 600 can be used to decorrelate inputs from microphones, outputs to speakers, or other suitable sound signals.

Method 600 begins at 602 where an input is received. In one exemplary embodiment, the input can be from a microphone, an input for provision to a speaker, or the suitable inputs. The method then proceeds to 604.

At 604, a frequency range is determined. In one exemplary embodiment, the frequency range can be optimized for a specific input, such as where a microphone is used for receiving sound from a specific sound source having a predetermined frequency range, for audio output signals that are to be amplified over a speaker that has been optimized for a certain frequency range, or other suitable frequency ranges. Likewise, method 600 can be performed on a signal that can vary over a wide frequency range, such that the frequency range determined at 604 is a selected for a specific frequency band to be decorrelated. Other suitable embodiments can also or alternatively be used. The method then proceeds to 606.

At 606, it is determined whether a change in the frequency range is required. In one exemplary embodiment, when the input has a frequency variation such that a range adjustment is required, the method can proceed to 608. Otherwise, where a frequency range is set and is not varied, the method proceeds to 612.

At 608, the noise frequency for the decorrelator is adjusted. In one exemplary embodiment, noise frequencies can be set so as to prevent generation of audio artifacts from noise variations that are greater than a predetermined range, such as a noise frequency that is related to the frequency of the input signal. The method then proceeds to 610 where a first order filter is adjusted. In one exemplary embodiment, the first order filter and noise frequency can be related so as to provide a controllable level of decorrelation so as to prevent generation of audio artifacts. The method then proceeds to 612.

At 612, it is determined whether a variable input is being received. In one exemplary embodiment, the input being processed can be received from a microphone such that the decorrelation is based on the frequency range of the signal being received. Likewise, the frequency can be variable based on a user control for a multiple speaker system or other suitable inputs. If it is determined at 612 that a variable input is not received the method proceeds to 614 and terminates. Otherwise, the method returns to 602.

In operation, method 600 allows an input signal to be decorrelated so as to change its phase based on a randomly generated noise frequency. Method 600 thus allows input signals from microphones, output signals to speakers, or other suitable signals to be phase decorrelated so as to prevent the generation of audio artifacts that can result from phase distortions between received signals at different microphones, phase distortions resulting from crossover between speakers, or other phase distortions.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. A system for processing audio data comprising:
a left channel system receiving a first channel of audio data;
a right channel system receiving a second channel of audio data;
a decorrelator coupled to one of the left channel system and the right channel system and providing a random phase shift to one of the first channel of audio data and the second channel of audio data, respectively;
a delay coupled to one of the left channel system and the right channel system and providing a delay to one of the first channel of audio data and the second channel of audio data; and
wherein the delay causes an apparent location of a source to a listener to occur in a single location.

2. The system of claim 1 comprising two decorrelators, each decorrelator coupled to one of the left channel system and the right channel system and providing a random phase shift to one of the first channel of audio data and the second channel of audio data, respectively

3. The system of claim 1 wherein the delay is a variable delay, and wherein changing the amount of the delay causes the apparent location of the source to the listener to change.

4. The system of claim 1 further comprising a filter coupled to one of the left channel system and the right channel system and filtering one of the first channel of audio data and the second channel of audio data, respectively.

5. The system of claim 1 wherein the left channel system receives a plurality of first channels of audio data, the right channel system receives a plurality of second channels of audio data, each corresponding to one of the plurality of first channels of audio data, a plurality of delays, each coupled to one of the left channel system and the right channel system and providing a delay to one of the pluralities of first channels of audio data and pluralities of second channels of audio data, and wherein the delay causes an apparent location of each of a plurality of sources to a listener to occur in a different location relative to each other source.

6. The system of claim 5 further comprising a plurality of decorrelators coupled to one of the left channel system and the right channel system, each decorrelator providing a random phase shift to one of the plurality of first channels of audio data and one of the plurality of second channels of audio data, respectively.

7. A method for processing audio data comprising:
receiving a first channel of audio data and one or more additional channels of audio data, each first channel of audio data and additional channels of audio data associated with a corresponding source;
introducing a delay to each of the first channel of audio data and additional channels of audio data;
decorrelating a phase of one or more of the first channel of audio data and a phase of one or more of the additional channels of audio data; and
summing each of the delayed first channels of audio data and the delayed additional channels of audio data to create a left channel stereo output and a right channel stereo out, wherein the left channel of audio data and right channel of audio data provide a different apparent spatial location for each of the first channel of audio data and additional channels of audio data.

8. The method of claim 7 wherein decorrelating the phase of the first channel of audio data and the phase of one or more of the additional channels of audio data comprises randomly varying one or more of the phase of the first channel of audio data and the phase of the second channel of audio data.

9. The method of claim 7 wherein the first channel of audio data and the additional channels of audio data are monaural signals.

10. The method of claim 7 wherein decorrelating the phase of the first channel of audio data and the phase of one or more of the additional channels of audio data comprises randomly varying the phase of at least one of the first channel of audio data and the phase of at least one of the additional channels of audio data.

11. The method of claim 7 wherein introducing the delay to the first channel of audio data comprises introducing a variable delay to the first channel of audio data.

12. The method of claim 7 further comprising filtering one or more of the first channel of audio data and the additional channels of audio data with a pinnae model filter.

13. The method of claim 7 further comprising filtering one or more of the first channel of audio data and the additional channels of audio data with a low pass filter.

14. A system for processing audio data comprising:
means for receiving a first channel of audio data;
means for receiving a second channel of audio data; and
means for decorrelating a phase of the first channel of audio data and a phase of the second channel of audio data.

15. The system of claim 14 further comprising means for providing a delay to one of the first channel of audio data and the second channel of audio data.

16. The system of claim 15 wherein the means for providing the delay to one of the first channel of audio data and the second channel of audio data comprises means for providing a fixed delay.

17. The system of claim 14 further comprising means for filtering one of the first channel of audio data and the second channel of audio data, respectively.

18. The system of claim 15 wherein the means for providing the delay to one of the first channel of audio data and the second channel of audio data comprises means for providing a variable delay.

19. The system of claim 14 further comprising means for filtering one of the first channel of audio data and the second channel of audio data, respectively, with a pinnae model filter.
